(19) United States
(12) Patent Application Publication
(10) Pub. No.: US 2004/0183004 A1
(43) Pub. Date: Sep. 23, 2004

(54) Method and device for identification and authentication of an object

(75) Inventors: Matthias Niggemann, Berlin (DE); Manfred Paeschke, Basdorf (DE); Arnim Franz-Burgholz, Falkensee (DE); Hans Zerbel, Berlin (DE); Kurt Hecht, Hartsville, PA (US); Christopher Freyman, Alburtis, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Accu-Sort Systems, Inc., Hatfield, PA

(21) Appl. No.: 10/393,900

(22) Filed: Mar. 20, 2003

(51) Int. Cl. G01N 21/64

(52) U.S. Cl. 250/271

(57) ABSTRACT

The invention refers to a method and device for identification and authentication of an object by means of coded information applied to the object. The function of said method and device is based on the principle of a laser scanner comprising two photoelectric detectors provided with decoding devices. In a first measuring channel and in classical manner an open coding in the form of a barcode is registered based on the different reflection/absorption of light at dark and light spots. In a second measuring channel the coded safety information applied on the same object is detected. By preference, the latter information is applied in form of luminescent safety pigments/coloring substances. By means of the source of light of the barcode scanner said safety pigments/coloring substances are excited at a defined optical wave length and show a specific luminescence in another wave length band. By preference, the detector device of the second measuring channel is provided with a wave length selecting element.

### FIELD OF INVENTION

The invention refers to a method and a device for identification and authentication of an object, in particular documents, valuable products or consumer goods.

### BACKGROUND

Methods and devices to identify objects by means of coded indicia, such as barcodes, which are applied on their surfaces are well known. The openly encoded information provided on consumer goods, documents, valuable products or other objects may be read by instruments, such as optical or barcode scanners. Such scanners typically have a source of light, for example a laser diode, that produces a scanning ray which illuminates the code on the object. The light reflected back from the code is supplied to a senor or detector. That information is available for further processing operations.

The coded information may comprise all kinds of known codes such as, for example, Code 2/5 Industrial, Code 2/5 Interleaved, EAN 8, EAN 13, Code 39, Code 39 extended, Code 93, Code 128, UPC Version A, UPC Version E, Codebar, PDF 417, Codablock, Code 49, or Code 16 K. This coded information is typically applied by standard printing processes such as, for example, relief printing, printing with a deep edge plate, offset printing, screen printing, flexo printing, needle matrix printing, ink ray printing, thermo printing, or laser printing. The general requirements for alignment, size, width of module, color, background color and so forth are established for each of the symbologies.

### SUMMARY

Using the known barcode scanner does not allow one to identify objects and check their authenticity at the same time. Therefore, it is the object of the invention to provide a method and a device for identifying an object by visibly coded information, such as the typical barcode, and at the same time identify an invisible authenticity code on the same object.

### BRIEF DESCRIPTION OF THE DRAWINGS

Based on the drawing figures an embodiment example of the invention is described in detail as follows.

FIG. 1 is a diagrammatic illustration of a scanner in accordance with the invention;

FIG. 2 illustrates different arrangements for openly coded and safety coded information;

FIG. 3 illustrates a means for limiting the window for detection of the safety information or invisible code;

FIG. 4 illustrates a filter arrangement for selecting a wavelength “λ”;

FIG. 5 illustrates graphically the selected wavelengths from the filters of FIG. 4;

FIG. 6 illustrates graphically the detection of a falsification of a mark detected in both channels; and

FIG. 7 illustrates an application where the object is presented to a bar code scanner while it is motion.

### DETAILED DESCRIPTION OF THE PREFERRED EMBODIMENT

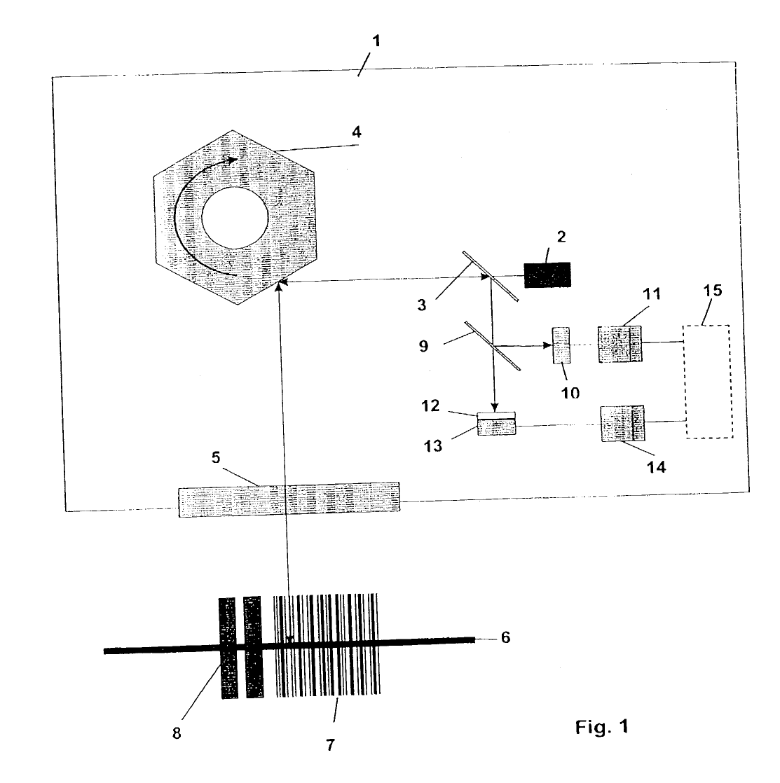

By preference, the combined identification and authentication unit, as shown in FIG. 1, is arranged in a common housing 1.

The device employs the principle of a laser scanner known from prior art, however, it includes at least two sensors or detectors of different sensitivities instead of the single sensitivity detector(s) of the known devices. That is to say, it is the detector or sensor which must be available in different ranges, not merely multiple sensors of the same range. Typically reflected light from an openly visible barcode is registered in a defined channel based on the different reflection/absorption of reflected light from dark and light spots (black-white spots in ideal circumstances). The detection of invisible coded information from the same object is carried out in a second defined channel. As used herein, invisible coded information refers to that which is not detectable by the human eye under normal conditions of use. Preferably, the invisible coded information is applied to the item in the form of luminescent safety pigments/coloring substances. Such luminescent substances are known, however, their formulations are typically preserved as trade secrets by companies/organizations working in the authentication field. Notwithstanding that formulations for such substances are available, having knowledge of the desired luminescent properties allows independent formulation of usable substances.

When such substances are excited at a defined optical wave length by the scanner's light source, they show a specific luminescence in wave length range different than that associated with the visible coded symbology. This different specific luminescence will be registered by the assigned detector in the second channel. By preference, the detector device of the second measuring channel is provided with a wave length selecting element, for example an interference filter.

The invention allows a quick and simple mechanical identification/authentication of documents or valuable products such as, bank notes, identity cards, coupons, stamps, checks, security labels, books, return deposit labels and the like.

The invention may be used for all known scanners, for example slot reading devices, line scanners, screen scanners, bidirectional and up to omni-directional scanners working on the basis of known light source illumination and reflection.

All sources of light known from prior art may be used as sources of light, in particular laser diodes. The typical thing is that these laser diodes emit light in the visible, red wave length range, for example at 635, 650, 660, 670, and 685 nm. Furthermore, laser diodes emitting in the non-visible wave length range, for example at 780, 808, 850, 950, 980, 1,300, and 1,550 nm, may be used as well. Of course, the laser diode used must be tuned to the exciting band of the safety pigment/safety coloring substance to be detected.

By preference, the scanner is provided with one laser diode only. However, it will also be possible to use an embodiment having two laser diodes emitting at different wave lengths. This embodiment is suitable when the laser diode is suitable for the openly coded barcode, but is of a wavelength that is not suitable for reading the humanly invisible authentication code. Put into concrete terms this means that a barcode readable at a wave length in the range of 630 through 670 nm is necessarily not detectable by illumination from a laser diode in the field of infrared light depending on the printing color utilized. Therefore, a scanner designed as such comprises two sources of light and at least two detectors.

The material of photoelectric elements used in detector devices, for example on the basis of Si or GaInAs and so forth, and the wave length selecting elements like, for example, cut-on filters or interference filters and so forth, must be tuned to the wave length to be measured.

Classical optical elements like prisms and grids may also be used as further wave length selecting elements. In this way a spectral resolution of the luminescent safety feature is achievable, if necessary, and this results in a further deterrent to copying the safety feature. In this case, a quickly working CCD line camera may also be used as a detector.

The coded safety information includes a luminescent substance in form of a pigment or coloring substance. The material used comprises the property to show emissions at one or several other wave lengths when excited optically with a defined wave length. As a rule, both down-converting and up converting effects may be used, i.e. emissions at lower or higher wave lengths relating to the excitation wave length.

By preference, material may be utilized which may be excited by a standard laser diode commonly associated with barcode scanners. Non-visible wave length field emitting laser diodes may be used as well.

### EXAMPLES

Excitation at 650 nm, maximum emission at 800 nm

Excitation at 980 nm, maximum emission at 550 nm

Excitation at 980 nm, maximum emission at 1,400 nm

Also, material may be used showing more than one emission band. By selecting the corresponding filters, in particular narrow-band filters, an emission band may be selected for detection purposes. For measuring reasons, it is advantageous if the stokes or anti-stokes shift is as large as possible.

The safety feature of the invisible code may be developed differently, for example:

geometrical forms (rectangle, square, circle . . . ) placed in close proximity to the visible symbology as desired;

geometrical forms placed at a designated position, but within the area covered by the scanning line(s);

laminar printing of the invisible feature beneath the barcode, personalization by a barcode printed subsequently (barcode printed in black, fluorescence absorbed selectively) which nearly results in a fluorescing “negative barcode”;

direct printing of an additional coding, for example a barcode provided with a fluorescing color.

The light having a wave length of λ₁ emitted by a laser diode 2 passes a semi-translucent or dichroic mirror and falls on a revolving mirror unit 4. The revolving mirror unit 4 produces a scanning ray 6 which falls through window 5 of housing 1 on barcode 7 and a coded safety feature 8 of an object and scans said barcode 7 and coded authenticity feature 8. By means of the impinging light of wave length λ₁ feature 8 is excited to illuminate and emits luminescence light of wave length 2. The light of wave length λ₁ reflected more or less from the light or dark spots of barcode 7 and luminescence light of wave length λ₂ emitted by the safety feature is supplied via revolving mirror unit 4 and a mirror system comprising the first semi-translucent or dichroic mirror 3 and a second semi-translucent or dichroic mirror 9 to a detector device. The light with wave length λ₁ reflected by the barcode is registered in a first detector 10, and the barcode information is decoded by decoder 11 subsequently.

A wave length selecting element 12, for example an interference filter, is arranged in a ray channel of a second detector 13, which element 12 allows that light having a wave length λ₂ is passing only. In this manner the second detector 13 registers the luminescence light selectively, which luminescent light is having a wave length λ₂ emitted from the safety feature. The coded safety information is decoded with the help of a second decoder 14 then.

With the help of an analysis device, the object may be identified and authenticated by means of decoding the openly visible information 7 and decoding the invisible information 8. The analysis device may be integrated in decoders 11, 14 or developed as separate unit 15 connected with the decoders. Also, the analysis device may be developed as a unit being connectable externally, for example in form of a PC provided with a suitable analysis software.

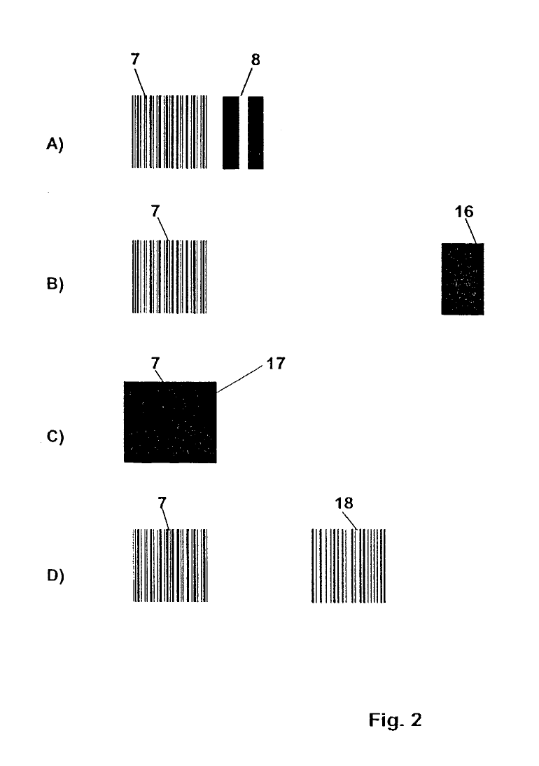

FIG. 2 shows different possibilities for arranging the normal commercial information with the security information.

FIG. 2A) shows a development as shown in FIG. 1. Information 7 coded openly comprises a barcode, safety information 8 comprising two color set off from the barcode and luminescent when excited accordingly.

FIG. 2B) shows a laminar area acting as safety feature 16 and set off from barcode 7, which area is made of a luminescent layer.

Barcode 7 shown in FIG. 2C) is backed with the luminescent substance forming safety feature 17.

Finally and apart from barcode 7 FIG. 2D) shows a safety feature based on a luminescent substance, which safety feature itself is developed as barcode 18.

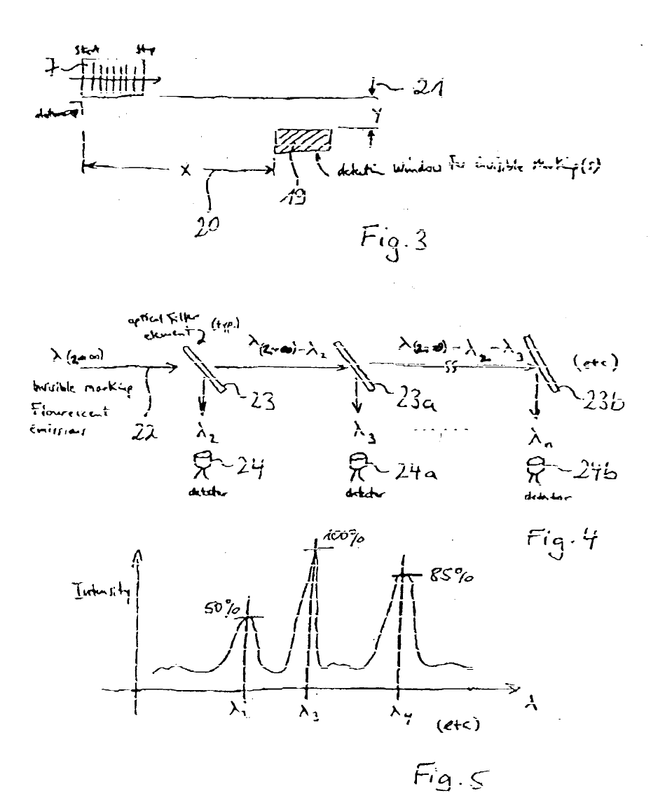

In accordance with FIG. 3 additional security may be achieved in the identification or authenticity of an object as such that the mutual position of the open coded information 7 applied to the object and the coded security information 19 is detected by the identification and authenticity unit. If the detected information and security features and their mutual positions coincide in a given range of tolerance with the expected features and positions, i.e. for example distance 20 in direction x and distance 21 in direction y create a window W where the information from the object is expected for authentication. If features and positions do not coincide as expected at W, the object is treated as a falsification.

It is illustrated in FIG. 4 that starting from a registered emission 22 of the security feature to be tested, several wave lengths λ2, λ3, λ4, etc. or fluorescence bands can be detected by using selective optical filters 23, 23a, 23b, etc. and detectors 24, 24a, 24b, etc. This provides a so-called spectroscopic fingerprint of a substance included in the security feature as shown, for example, in FIG. 5. Also, a spectral decomposition of the optical radiation emitted by the security feature can be carried out, e.g. by optical grids or prisms. This spectrum may, for example, be illustrated and analyzed by means of a CCD camera.

In addition, the relative intensity of each wave length λ2, λ3, λ4 or frequency band may be detected. Several detected wave lengths and their intensities are illustrated in FIG. 5 which are normalized on the amplitude of the strongest wave length. According to the utilization of the substance(s) included in the security feature and its/their concentrations a specific fingerprint of the security features may be produced as such with respect to emitted wave lengths and intensities, which fingerprint is very difficult to imitate.

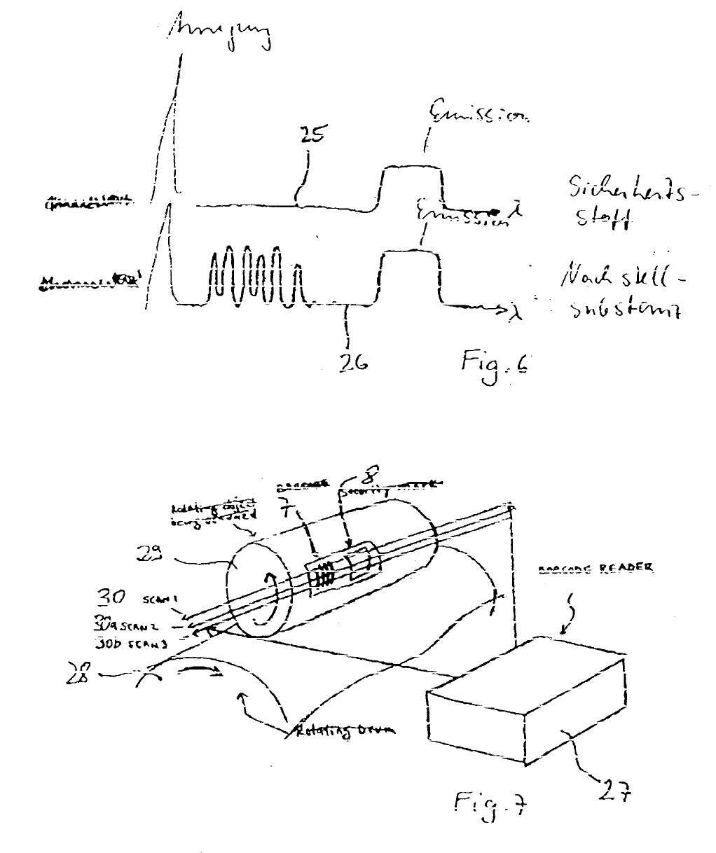

We have tried to eliminate imitations of the security substance spectrum by using wide-band fluorescent substances, for example organic substances, that often fluoresce in direct spectral proximity to the wave length of the excitation light. This fluorescence may be detected by the detector used for reading the barcode in the visible wave length range, and in such a way a falsification attempt can be identified. FIG. 6 shows the spectrum of exciting emission 25, channel 1, and the spectrum 26, channel 2, emitted by the security feature, which spectrum 26 shows a fluorescence emission both in the exciting wave length range and in another wave length range. In this example, a valid security mark or code should only be detected in the invisible channel 1 and not in the visible channel 2. Markings that fluoresce in both channels would be identified as falsifications.

And finally FIG. 7 shows a further arrangement to verify an object provided with open coded information 7 and security features 8. A scanner device 27 in the form of a barcode reader modified in accordance with the invention is provided, which scanner device 27 is to verify information 7 and one security information 8 of a rotating object 29. Said object 29 is rotated by a rotating drum 28, however, said object 29 may also be arranged directly on rotating drum 28. The sensing rate of scanner 27, the dimensions of security features 8 and the rotation speed of drum 28 are concerted as such that, when scanning the object, the security information 8 are recognized one after another during a given number of scanning steps, for example three scanning steps 30, 30a, 30b. If the number of successful scanning steps 30, 30a, 30b is smaller or greater than the preselected number this may be an indication that the object, the security information or the reading system was manipulated or that the authenticity of the object is not given.

What we claim:

1. A method for identification and authentication of coded information applied to an object, characterized by the steps:
scanning of the surface of the object provided with coded information (7, 8) by means of a scanning ray (6) produced by a source of light (2) and a deflecting unit (4);
registration of coded information (7, 8) by means of the light reflected and/or emitted from the scanned surface by means of optical detection devices (10, 13) with a first measuring channel for the registration of openly coded information (7) and a second measuring channel for the registration of safety coded information (8);
decoding of information (7, 8) registered by detection devices (10, 13); and
identifying and authentication of the object by means of information coded openly (7) and decoded safety information (8; 16; 17; 18).

2. A method in accordance with claim 1, characterized in that the source of light (2) emits light of a defined wave length or a defined wave length band.

3. A method in accordance with claim 1, characterized in that the first measuring channel registers light of at least one defined wave length or a defined wave length band only.

4. A method in accordance with claim 1, characterized in that the second measuring channel registers light of a defined wave length or a defined wave length band only.

5. A method in accordance with claim 1, characterized in that the wave lengths or wave length bands processed by the measuring channels are different.

6. A method in accordance claim 1, characterized in that the openly coded information (7) is a barcode.

7. A method in accordance with claim 1, characterized in that the safety information (8; 16; 17; 18) is presented in a luminescent substance.

8. A method in accordance with claim 1, characterized in that openly coded information (7) and coded safety information (8) have a predetermined spatial relation between them.

9. A method in accordance with claim 1, characterized in that the luminescent substance has wavelengths of λ2→∞ that produce specific emissions from optical excitation with a particular wave length λ1.

10. A method in accordance with claim 1, characterized in that a spectroscopic decomposition of the optical radiation emitted by the security feature is carried out, where the spectrum received is illustrated and analyzed by a digital camera.

11. A method in accordance with claim 1, characterized in that several wave lengths λ2, λ3, λ4 or fluorescence bands may be detected by using several selective optical filters (23, 23a, 23b) and several detectors (24, 24a, 24b) and that a spectroscopic fingerprint of a substance included in the security feature may be detected as such.

12. A method in accordance with claim 11, characterized in that the relative intensity of each wave length λ2, λ3, λ4 detected or each frequency band is detected in addition.

13. A method in accordance with claim 1, characterized in that an existing fluorescence of the security feature is detected in the visible wave length range by the detector in addition, which detector is used for barcode reading purposes.

14. A method in accordance with one of the preceding claims, characterized in that a scanner device (27) is provided which verifies information (7) and one security information (8) of a rotating object (29), wherein the sensing rate of scanner (27), the dimensions of security feature (8) and the rotation speed of object (2) are concerted as such that, when scanning the object, the security information (8) are recognized one after another during a given number of scanning steps.

15. A device for the identification and authentication of an object by means of coded information applied on the object and characterized by
a source of light (2);
a deflecting unit (4) producing a scanning ray scanning the surface of an object;
optical detection devices (10, 13) for the registration of scanned coded information (7, 8) with a first measuring channel for the registration of information coded openly (7) and a second measuring channel for the registration of coded safety information (8; 16; 17; 18);
decoding devices for decoding registered information (7; 8; 16; 17; 18) and
internal or external devices (15) for the identification and authentication of the object by means of information decoded openly and decoded safety information.

16. A device in accordance with claim 15, characterized in that the source of light (2) is a semiconductor laser.

17. A device in accordance with one of claim 15, characterized in that detection devices (10; 13) comprise photoelectric elements.

18. A device in accordance with claim 15, characterized in that wavelength selecting optical elements (12) are arranged in the ray channel in front of the detection devices.

19. A device in accordance with claim 15, characterized in that information coded openly (7) are barcodes or symbols similar to barcodes.

20. A device in accordance with claim 15, characterized in that coded security information (8; 16; 17; 18) comprise luminescent substances which, when illuminated with light of a particular first wave length λ1, emit radiation of the same and/or at least a second wave length λ2.

21. A device in accordance with claim 15, characterized in that the open coded information (7) and the coded security information (8) are applied to the object in a determined spatial relation to each other.

22. A device for detecting information on an object having information in both human visible and invisible formats, the device comprising:
a light source for illumination of the information;
a first detector that is responsive to light reflected from the illuminated information in human visible format and outputs a signal representing that information;
a second detector that is responsive to light reflected from the illuminated information in human invisible format and outputs a signal representing that information; and,
a means for receiving at least the output of the second detector and generating an output evaluating at least the information in the invisible format.
